(19) United States
(12) Patent Application Publication
(10) Pub. No.: US 2025/0220004 A1
(43) Pub. Date: Jul. 3, 2025

(54) Accurate Timestamp Measurements for a Single Step Precision Time Protocol

(71) Applicant: Altera Corporation, San Jose, CA (US)

(72) Inventors: Ganapathi Singaravelu, Bangalore (IN); Dinesh Kotti, Saratoga, CA (US); Luan Bui, San Jose, CA (US); Xiaokang Xu, San Ramon, CA (US); Rajkumar Kadam, Bangalore (IN); Raghucharan Boddupalli, Bangalore (IN)

(21) Appl. No.: 18/399,600

(22) Filed: Dec. 28, 2023

(51) Int. Cl. H04L 9/40; H04J 3/06

(52) U.S. Cl. CPC H04L 63/0435; H04J 3/0667; H04L 63/123

(57) ABSTRACT

Systems or methods of the present disclosure may provide an integrated circuit system including programmable logic circuitry and a transceiver tile coupled to the programmable logic circuitry, the transceiver tile including a transceiver subsystem. The transceiver subsystem may be configurable to store a precision time protocol (PTP) packet, generate a first copy of the PTP packet with a first timestamp, a second copy of the PTP packet with a second timestamp, and a third copy of the PTP packet with a third timestamp, encrypt each of the first copy of the PTP packet, the second copy of the PTP packet, and the third copy of the PTP packet, and transmit either the first copy of the PTP packet, the second copy of the PTP packet, or the third copy of the PTP packet.

### BACKGROUND

The present disclosure relates generally to data communication. More particularly, the present disclosure relates to enabling accurate timestamp measurements for single-step Precision Time Protocol (PTP) packets with Media Access Control security (MACsec).

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Precision Time Protocol (PTP) is a protocol to enable clock synchronization in a network, such as a computer network. However, PTP may be susceptible to security threats that may impact the clock synchronization and reduce accuracy. To prevent spoofing and attacks to security, encryption may be involved for data passing through PTP. PTP may use single-step PTP (e.g., a one-step clock), two-step PTP (e.g., a two-step clock), or both. Two-step PTP involves sending a timestamp of a sync message in a follow up message, which is handled by software and may increase the software complexity. Further, the single-step PTP involves sending the timestamp within the sync message. However, using single-step PTP may be challenging due to variable latency in a data path of hardware. Additionally, the accuracy of the timestamp aids in the enablement of time synchronization between electronic devices. A lack of time synchronization between the electronic devices may impact functionality of the electronic devices.

### BRIEF DESCRIPTION OF THE DRAWINGS

Various aspects of this disclosure may be better understood upon reading the following detailed description and upon reference to the drawings in which:

FIG. 1 is a block diagram of an integrated circuit system, in accordance with an embodiment of the present disclosure;

FIG. 2 is an example of circuitry that may be employed by a transceiver subsystem of the integrated circuit system of FIG. 1 used in performing a single-step Precision Time Protocol (PTP), in accordance with an embodiment of the present disclosure;

FIG. 3 is a flow chart of a method for performing single-step PTP in an encrypted manner such as via Media Access Control security (MACsec), in accordance with an embodiment of the present disclosure;

FIG. 4 is diagram of circuitry employed in a transceiver subsystem to perform the secure single-step Precision Time Protocol (PTP), in accordance with an embodiment of the present disclosure; and

FIG. 5 is an example illustration of an example table including fields for performing profiling, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Embodiments of the present disclosure are directed to enabling accurate timestamp measurements for single-step Precision Time Protocol (PTP) packets with Media Access Control security (MACsec). An integrated circuit system (e.g., an integrated circuit package) may store an incoming PTP packet in a per port first in, first out (FIFO) (e.g., a PTP packet buffer). Further, the integrated circuit system may maintain a history of encrypted and non-encrypted packets transmitted at the per port FIFO for a number of clocks, which may be referred to as profiling. For example, the integrated circuit system may maintain the history of a timing associated with a pipeline depth for an input of MACsec to an output of MAC. The integrated circuit system may then calculate a timestamp based on the history and an estimated latency for a current PTP packet to reach the output of the MAC. Further, the timestamp may be inserted into the PTP packet (e.g., the current PTP packet).

Moreover, the integrated circuit system may generate multiple copies of the PTP packet with different time stamps. In one example, the integrated circuit system may generate a first copy of the PTP packet with a first timestamp, a second copy of the PTP packet with a second timestamp, and a third copy of the PTP packet with a third timestamp. The first timestamp, the second timestamp, and/or the third timestamp may respectively include an exact timestamp, the exact timestamp plus a value, and the exact timestamp minus a value.

Additionally or alternatively, the integrated circuit system may employ a selection of a range of consecutive values and/or the use of an uncertainty multiplier or a port rate multiplier. The integrated circuit system may then respectively encrypt the first copy of the PTP packet, the second copy of the PTP packet, and the third copy of the PTP packet. After encryption, the first copy of the PTP packet, the second copy of the PTP packet, and the third copy of the PTP packet are sent to the MAC. Further, the original timestamp used for the first copy of the PTP packet, the second copy of the PTP packet, and the third copy of the PTP packet may also be sent as metadata to the MAC.

At an output stage of the MAC, the integrated circuit system may compare each of the first timestamp, the second timestamp, and the third timestamp to a time-of-day (TOD) value. Additionally, the integrated circuit system may select either the first copy of the PTP packet, the second copy of the PTP packet, or the third copy of the PTP packet based on the comparison. For example, the integrated circuit system may select the PTP packet that is closest in value to the TOD value. The integrated circuit system may then transmit either the first copy of the PTP packet, the second copy of the PTP packet, or the third copy of the PTP packet based on the selection. As such, the integrated circuit system may accurately timestamp the single-step PTP packets, while accounting for variable latency.

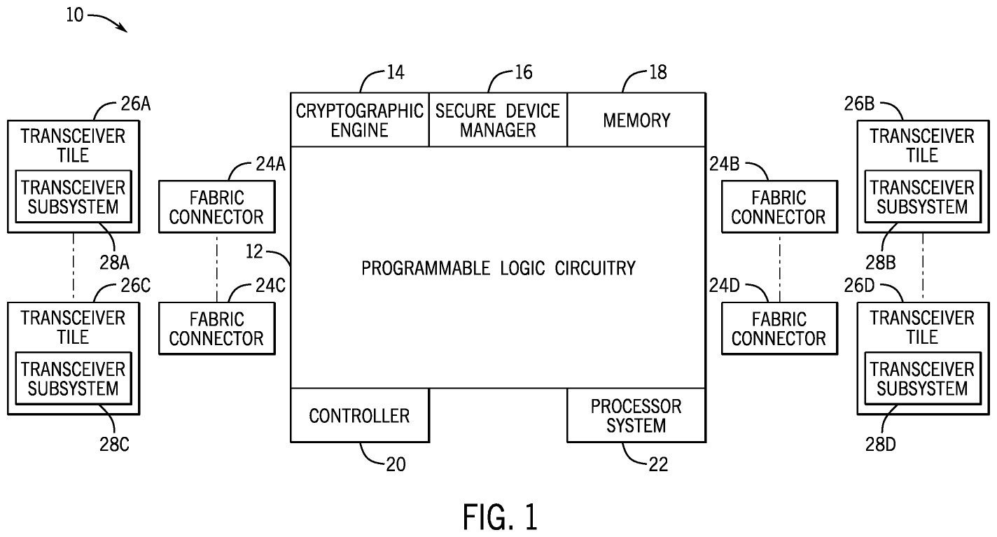

With the foregoing in mind, FIG. 1 is a block diagram of an integrated circuit system 10 (e.g., an integrated circuit package, a programmable logic device). The integrated circuit system 10 may include programmable logic circuitry 12 (e.g., programmable logic fabric, field programmable gate array (FPGA)), which may include programmable routing circuitry and programmable logic (sometimes referred to as logic array blocks (LABs) or configurable logic blocks (CLBs)). The programmable logic circuitry 12 may include circuitry that can be configured or programmed to implement specific logic functions. For example, configuration data may be used to program all of or a portion of the programmable logic circuitry 12 to implement circuit designs to carry out numerous operations or functions.

The programmable logic circuitry 12 may be part of an integrated circuit that includes a cryptographic engine 14; a device controller, such as a secure device manager (SDM) 16; a memory 18; hardened memory controller(s) 20, and a hardened processor system 22. The cryptographic engine 14 may include a hardware component or a software component (e.g., running on the hardened processor system 22) that is designed to perform cryptographic operations securely. For example, the cryptographic engine 14 may execute cryptographic algorithms such as encryption, decryption, hashing, and/or verification. The SDM 16 may receive bitstreams of configuration data and provide the configuration to be programmed into the programmable logic circuitry 12. The SDM 16 may also provide protection for sensitive data and the cryptographic operations, such as by storing cryptographic keys. The SDM 16 may be designed to be resistant to security attacks, such as attempts to extract sensitive information or modification of the functionality of the SDM 16.

The memory 18 may include any suitable memory included in integrated circuit, such as an embedded static random-access memory (eSRAM). The hardened memory controller(s) 20 may be a hardware component that may manage and control communication between the programmable logic circuitry 12 or the hardened processor system 22 and other memory (e.g., external memory such as a version of double data rate (DDR) memory or high-bandwidth memory (HBM)).

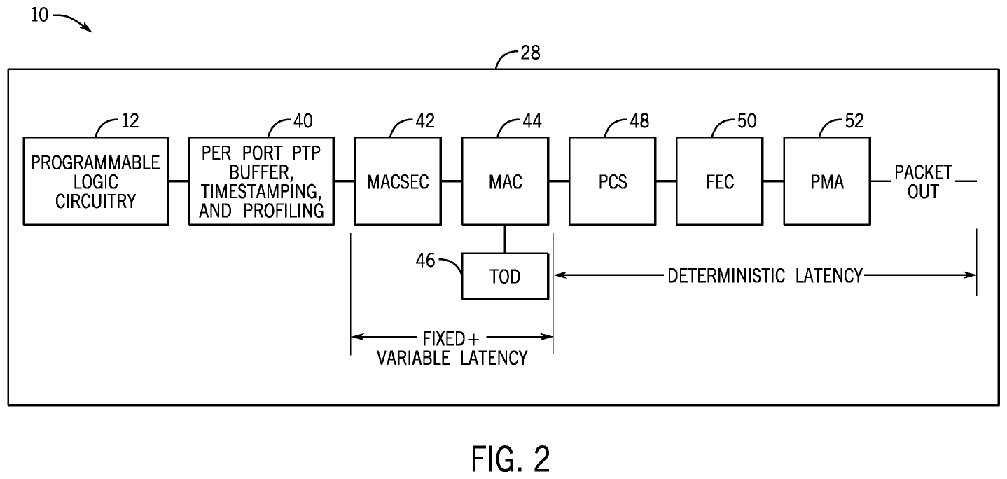

The integrated circuit system 10 may include fabric connectors 24 (e.g., 24A, 24B, 24C, 24D), which may enable communication and data exchange between multiple processing cores or memory blocks in the integrated circuit system 10. The fabric connectors 24 may also enable connections between different components or blocks (e.g., logic blocks) within the integrated circuit system 10. As an example, the fabric connectors 24 may include an Embedded Multi-die Interconnect Bridge (EMIB). As another example, the fabric connectors 24 may enable communication via Universal Chip Interconnect Express (UCIE), which is a connection protocol that facilitates data transfer and communication between various components or systems. Further, the integrated circuit system 10 may include transceiver tiles 26 (e.g., 26A, 26B, 26C, 26D). The transceiver tiles 26 may each contain transceivers that enable transmission or receipt of data over suitable communication links. The transceiver tiles 26 may be configurable to include a certain number of transceivers with specific operating parameters. Further, the transceiver tiles 26 may support different communication protocols, enabling compatibility with various other devices or systems. The transceiver tiles 26 may each include a transceiver subsystem 28 (e.g., 28A, 28B, 28C, 28D), which may enable performance of operations described herein, such as transportation of a packet and/or performance of the single-step PTP. Additional details regarding the transceiver subsystem 28 will be described below with respect to FIGS. 2-5.

With the foregoing in mind, FIG. 2 is a diagram of an example of circuitry that may be employed by the transceiver subsystem 28 of the integrated circuit system 10 used in performing the single-step PTP, in accordance with an embodiment of the present disclosure. For example, the transceiver subsystem 28 may include circuitry incorporated in an FPGA (e.g., the programmable logic circuitry 12). The transceiver subsystem 28 may perform a time-critical protocol or process, such as Precision Time Protocol (PTP). For example, the integrated circuit system 10 may include the programmable logic circuitry 12, the transceiver tiles 26, and each of the transceiver subsystems 28, which may communicate to perform the time-critical protocol or process. The programmable logic circuitry 12 may serve as an initiator in which the transceiver subsystem 28 transmits a packet (e.g., a PTP packet, a data packet, a communication packet). In some examples, the programmable logic circuitry 12 may generate the packet for transmission. In additional or alternative examples, the programmable logic circuitry 12 may initially receive the packet from another initiator and may forward the packet to a target recipient after receipt of the package. In some examples, the programmable logic circuitry 12 may transmit a timestamp with the packet. The timestamp may indicate when the programmable logic circuitry 12 transmits the packet.

The transceiver subsystem 28 may store the transmitted packet in a per port first-in-first-out (FIFO) buffer 40 (e.g., packet buffer, PTP packet buffer, per port PTP buffer). Further, the transceiver subsystem 28 may maintain a history of previously transmitted encrypted packets and/or unencrypted packets for an associated port for a previous number of clocks (e.g., 32 clocks, 64 clocks, and so on), which may be referred to as the profiling (e.g., using profiling logic). The timestamp transmitted with the packet may also be maintained (e.g., using timestamp logic). The programmable logic circuitry 12 may provide the timestamp based on an estimated amount of time the packet will take to leave a Media Access Control (MAC) pipeline and a latency (e.g., a predicted latency) associated with processing the packet from a Media Access Control security (MACsec) logic or circuitry 42 to an output of a MAC logic or circuitry 44. As an example, the transceiver subsystem 28 may perform an algorithm to determine the estimated amount of time the packet will take to leave the MAC pipeline.

Based on the history and the latency, the transceiver subsystem 28 may calculate a timestamp and insert the timestamp into the packet. Further, the transceiver subsystem 28 may generate a first copy of the packet with a first timestamp, a second copy of the packet with a second timestamp, and a third copy of the packet with a third timestamp. The first timestamp, the second timestamp, and the third timestamp may each be based on a number of bytes in a number of clock cycles (e.g., 128 clock cycles). Further, at least one of the first timestamp, the second timestamp, and the third timestamp may vary based on an inter-packet gap (IPG) variance. For example, the first timestamp may be based on the number of bytes in the number of clock cycles, the second timestamp may be based on the number of bytes in the number of clock cycles plus the IPG variance of 1 byte, and the third timestamp may be based on the number of bytes in the number of clock cycles plus the IPG variance of 2 bytes. In some embodiments, a range of each of the first timestamp, the second timestamp, and the third timestamp may be configurable to include three values, as well as an uncertainty multiplier or a port rate multiplier. For example, the range of values may include −2, −1, and 0, or the range of values may include 2, 4, and 6.

The MACsec logic 42 may receive the first copy of the packet, the second copy of the packet, and the third copy of the packet, which may each be unencrypted. Further, the transceiver subsystem 28 may send an indication to the MAC logic 44 to prevent insertion of a control frame (e.g., a Priority Flow Control frame) until a selected packet is sent out of the MAC logic 44. The MACsec logic 42 may then separately encrypt or encode each of the first copy of the packet, the second copy of the packet, and the third copy of the packet. For example, the MACsec logic 42 may use a security association key (SAK) to encrypt the first copy of the packet. After encryption, the MACsec logic 42 may transmit the first copy of the packet with the first timestamp, the second copy of the packet with the second timestamp, and the third copy of the packet with the third timestamp to an additional per port buffer, which may store each of the copies of the packets until the MAC logic 44 has an available slot. Moreover, the first timestamp, the second timestamp, and the third timestamp may be respectively sent as metadata with each of the associated first copy of the packet, the second copy of the packet, and the third copy of the packet.

It should be noted that the MACsec logic 42 and the MAC logic 44 may be run at a higher clock frequency to meet a line rate and compensate for a number of holes that may be created when encrypting each of the first copy of the packet, the second copy of the packet, and the third copy of the packet. In some embodiments, the MAC logic 44 may not send idles, but instead may send a packet from the non-timestamped packet buffers.

Transmission between the MACsec logic 42 and the MAC logic 44 may include a fixed latency and a variable latency. The fixed latency may refer to a consistent or predictable delay in transmission and/or processing of the packet, which may provide a stable and/or known timing for operations. The variable latency may refer to a changing or unpredictable delay in the transmission and/or the processing of the packet, which may provide a fluctuating and/or inconsistent timing for the operations. At the output of the MAC logic 44, the transceiver subsystem 28 may compare the first timestamp, the second timestamp, and the third timestamp to a time of day (TOD) value 46 and compensate for time between the MAC logic 44 and a Serializer Deserializer (SerDes). Indeed, the transceiver subsystem 28 may compensate for time between the MAC logic 44 and the SerDes because the MAC logic may not include a deterministic time between the MAC logic 44 and the SerDes. Thus, the time between the MAC logic 46 and the SerDes may need to be compensated.

The TOD value 46 may indicate a specific time within the day, which may enable scheduling or prioritization of various tasks and/or data transmissions based on the specific time. The transceiver subsystem 28 may then select either the first copy of the packet, the second copy of the packet, or the third copy of the packet whose timestamp is closest in value to the TOD value 46.

Moreover, the selected packet may be transmitted to a physical coding sublayer (PCS) 48, which is a data link layer that may handle encoding and/or decoding of signals before transmission or after receipt. The selected packet may then be transmitted to forward error correction (FEC) 50, which may detect and correct errors that may occur in the received packet without involving retransmission. Further, the selected packet may be transmitted to a physical medium attachment (PMA) sublayer 52, which is a sublayer that may interface with a physical medium to handle data serialization and/or deserialization for transmission. The selected packet is then transmitted out from the PMA sublayer 52 to a target recipient. Transmission from the PCS 48 to the PMA 52 and the packet being sent out to the target recipient may include a deterministic latency. The term “deterministic latency” means that the timing for the processing and/or the operation to occur may fall within a known, calculable, or consistent range of timing. Thus, the deterministic latency from the PCS 48 to the PMA 52 may be predictable and remain within specified limits. It should be noted that for reception of incoming packets, an incoming packet may be timestamped. Further, when the incoming packet is decrypted, the programmable logic circuitry 12 may obtain a reference of a source embedded timestamp and a timestamp for a time of entry of the incoming packet.

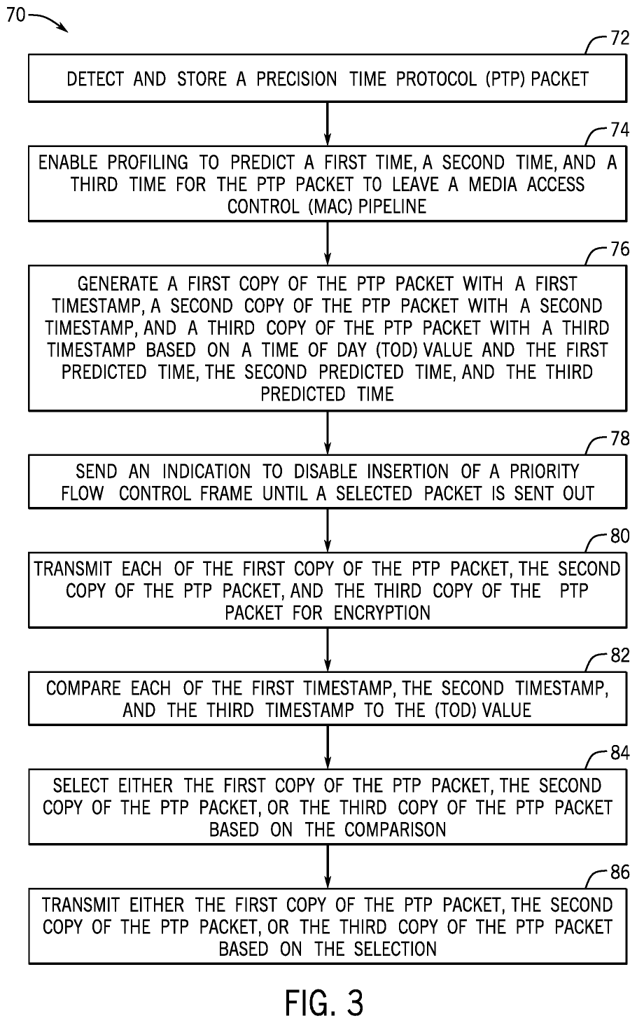

With the foregoing in mind, FIG. 3 is a flow chart of a method 70 for transmitting a secure PTP packet via MACsec, in accordance with an embodiment of the present disclosure. In some embodiments, the respective methods and/or one or more of procedures thereof may be performed by a single respective component or system, such as by the transceiver subsystem 28. In additional or alternative embodiments, multiple components or system may perform the procedures of the method 70, such as multiple components of the integrated circuit system 10. It should also be noted that additional procedures or steps may be performed with respect to the depicted method 70. Moreover, certain procedures of the method 70 may be removed, modified, and/or performed in a different order.

At block 72, the transceiver subsystem 28 may detect and store a PTP packet. For example, the transceiver subsystem 28 may store the PTP packet in the per port buffer 40. Moreover, at block 74, the transceiver subsystem 28 may enable profiling to predict a first time, a second time, and a third time for the PTP packet to leave a MAC pipeline. At block 76, the transceiver subsystem 28 may generate any suitable number of copies of the PTP packet with different respective timestamps. In one example, three copies are generated, but it should be appreciated that as few as two or as many as desired may be generated to accommodate a particular precision and variability that may be present in the system. In the example in which three copies are generated, a first copy of the PTP packet a first timestamp, a second copy of the PTP packet with a second timestamp, and a third copy of the PTP packet with a third timestamp may be generated based on the TOD value and the first predicted time, the second predicted time, and the third predicted time. For example, the first timestamp may be associated with 0 (e.g., in time), the second timestamp may be associated with −1 (e.g., 1 unit before in time), and the third timestamp may be associated with +1 (e.g., 1 unit after in time). It should be noted that the first timestamp, the second timestamp, and the third timestamp may be configurable to be associated with any suitable value. At block 78, the transceiver subsystem 28 may send an indication to disable insertion of a priority flow control frame until a selected packet is sent out.

At block 80, the transceiver subsystem 28 may transmit each of the first copy of the PTP packet, the second copy of the PTP packet, and the third copy of the PTP packet to the MACsec logic 42, which may then separately encrypt or encode each of the first copy of the PTP packet, the second copy of the PTP packet, and the third copy of the PTP packet. Further, at block 82, the transceiver subsystem 28 may compare each of the second timestamp, and the third timestamp to the TOD value 46. As described herein, the TOD value 46 may indicate the specific time within the day. The comparison may enable the transceiver subsystem 28 to determine which of the first timestamp, the second timestamp, or the third timestamp is closest in value to the TOD value 46.

At block 84, the transceiver subsystem 28 may select either the first copy of the PTP packet, the second copy of the PTP packet, or the third copy of the PTP packet based on the comparison, which may show which of the timestamp associated with the PTP packets is closest in value to the TOD value. Indeed, the transceiver subsystem 28 may perform the comparison to determine which of the first copy of the PTP packet, the second copy of the PTP packet, or the third copy of the PTP packet is closest in value to the TOD value 46. At block 86, the transmission circuitry may transmit either the first copy of the PTP packet, the second copy of the PTP packet, or the third copy of the PTP packet based on the selection. In this manner, the method 70 may support a reduction in latency and improved clock synchronization across devices on a network by enabling transmission of accurate time measurements for single-step PTP packets with the MACsec logic 42.

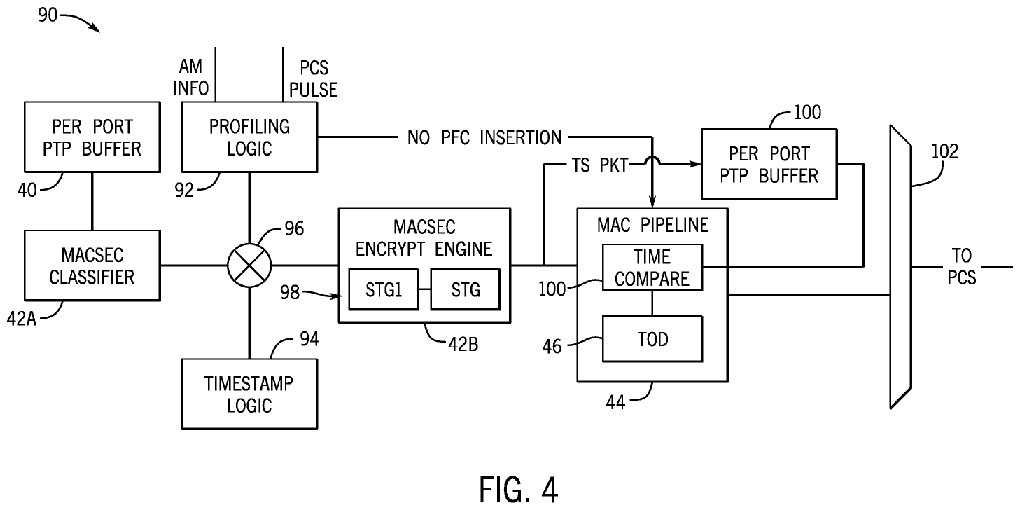

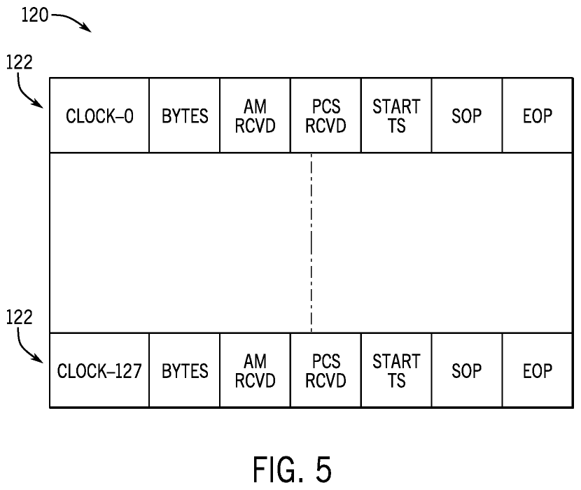

FIG. 4 is a block diagram of circuitry 90 employed in the integrated circuit system 10 to perform the secure single-step PTP transmission, in accordance with an embodiment of the present disclosure. As described herein, the transceiver subsystem 28 may store the transmitted packet in the per port FIFO buffer 40A (e.g., a per port PTP pre-MACsec buffer). Further, the transceiver subsystem 28 may maintain the history of previously transmitted packets using profiling logic 92. The profiling logic 92 may predict (e.g., project) a specific time the PTP packet may take to transmit given the history of the PTP packet previously sent in a prior number of clocks (e.g., 128 clocks). The profiling logic 92 may receive information from the MAC logic 44 (e.g., the MAC pipeline) to enable an increase in accuracy in prediction. For example, the profiling logic 92 may receive information related to an alignment marker (AM) pulse, a PCS insertion pulse, and an inter-packet gap (IPG) insertion pulse, which may each cause variable latency in the MAC logic 44. Additional details with regard to the profiling logic 92 will be described below with respect to FIG. 5.

Further, timestamp logic 94 may insert a determined or predicted timestamp indicative of when the programmable logic circuitry 12 transmits the packet and/or the metadata. In some embodiments, the variable latency may also be caused be insertion of PFC frames inside the MAC logic 44. Thus, the transceiver subsystem 28 may send an indication to the MAC logic 44 to prevent or disable insertion of the PFC until the selected packet is sent out of the MAC logic 44. Further, to account for IPG variation, the transceiver subsystem 28 may generate three packets (e.g., the first copy of the PTP packet, the second copy of the PTP packet, and the third copy of the PTP packet) based on the PTP packet.

The MACsec logic 42 may include a MACsec classifier 42A and a MACsec encryption engine 42B. The MACsec classifier 42A may provide information related to the number of clock cycles, an additional number of bytes added, classification of the PTP packets undergoing encryption, and/or whether a packet is encrypted. Further, the MACsec classifier 42A may provide information regarding a final size (e.g., in bytes) of the PTP packet for an associated port. Moreover, each output (e.g., data) of the MACsec classifier 42A, the profiling logic 92, and the timestamp logic 94 may be transmitted to a PTP packet generator 96. The transceiver subsystem 28 may then generate the first copy of the PTP packet including the first timestamp, the second copy of the PTP packet including the second timestamp, and the third copy of the PTP packet including the third timestamp based on the information obtained at the PTP packet generator 96.

As described herein, each of the first copy of the PTP packet, the second copy of the PTP packet, and the third copy of the PTP packet may be encrypted at the MACsec encryption engine 42B. The MACsec encryption engine 42B may include a number of pipeline stages 98 (e.g., hardware stages) that may be used to encrypt some or all of the first copy of the PTP packet, the second copy of the PTP packet, and the third copy of the PTP packet. The MACsec encryption engine 42B may then provide each of the encrypted first copy of the PTP packet, the second copy of the PTP packet, and the third copy of the PTP packet to the MAC logic 44.

After encryption at the MACsec encryption engine 42B, the first copy of the PTP packet, the second copy of the PTP packet, and the third copy of the PTP packet are sent to a per-port PTP buffer 100 (e.g., a per port PTP post MACsec buffer) to be stored. The first copy of the PTP packet, the second copy of the PTP packet, and the third copy of the PTP packet may be stored in the per port PTP buffer 100 to prevent each of the PTP packets from being sent to the MAC logic 44. The first copy of the PTP packet, the second copy of the PTP packet, and the third copy of the PTP packet may remain in the per port PTP packet buffer 100 along with their associated timestamps and/or metadata until an open slot (e.g., bubble, free slot) becomes available in the MAC logic 44. Thus, at least one of the copies of the PTP packets may be sent to the MAC logic 44. As an example, the per port PTP buffer 100 may include any suitable transitional buffer that may store the encrypted copies of the PTP packets, so that they may be sent out (e.g., immediately or almost immediately) when there is an available slot.

The MAC logic 44 may include time compare logic 100 and the TOD value 46. Thus, at the MAC logic 44, the first timestamp, the second timestamp, and the third timestamp may be compared to the TOD value 46 to select the packet that is closest in value to the TOD value 46 and/or to compensate for the time between the MAC logic 44 and the SerDes. For example, the packet closest in value to the TOD value 46 may be selected at selection circuitry 102 and transmitted to the PCS 48.

With the foregoing in mind, FIG. 5 is an example illustration of an example table 120 including fields for performing profiling by the profiling logic 92, in accordance with an embodiment of the present disclosure. Profiling may enable determination of the TOD value 46 the delta value, and/or may enable a determination regarding a number of bytes being transmitted at the time of PTP packet encryption. The delta value may be associated with a change in value between the first timestamp, the second timestamp, and/or the third timestamp. Further, the delta value may be determined using varying fields (e.g., inputs) detailed in the illustrated table 120. For example, a function of the profiling may include maintaining a number of bytes transmitted in a previous number of clocks (e.g., 128 odd clocks), a reference timestamp, a characteristic of the PTP packet, a MACsec latency, a MAC latency, the AM pulse from the MAC logic 44, and/or the PCS insertion pulse from the MAC logic 44. The information stored in the table 120 may provide a specific number of bytes that are in the MAC pipeline for the previous number of clocks. The number of bytes may then be converted to time using a mathematical formula. The conversion to time may be used as the timestamp for the PTP packet encryption by the MACsec encryption engine 42B.

As an example and as described herein, the table 120 may include various fields 122, such as history for each of the previous number of clocks, such as the bytes, the AM pulse, the PCS insertion pulse, a starting timestamp, a start of packet (SOP) signal (e.g., indicates initiation of data packet transmission), and an end of packet (EOP) signal (e.g., indicates conclusion or termination of the data packet transmission). The AM pulse may be associated with a pattern or a sequence of bits inserted into a data stream at intervals, which may enable determination of individual data frames within the data stream. The PCS insertion pulse may be associated with a signal or timing element inserted during an encoding process, indeed the PCS insertion pulse may be used as part of the encoding process to create the packet transmitted. The fields 122 may enable the transceiver subsystem 28 to account for alteration of the timestamp that may occur during transmission of the PTP packet due to the AM pulse and/or the PCS insertion pulse.

Moreover, the transceiver subsystem 28 may compensate for IPG variance for the previous number of clocks. The IPG variance may also result in an alteration of the timestamp during transmission. Thus, the transceiver subsystem 28 may calculate IPG variance compensating using a number of the EOP's in the table 120 for the previous number of clocks. The transceiver subsystem 28 may then generate the first timestamp, the second timestamp, and the third timestamp based on the number of EOP's in the table 120. For example, a first number of EOP's with IPG may be equal to 12 bytes, a second number of EOP's with IPG may be equal to 8 bytes, and a third number of EOP's with IPG may be equal to 10 bytes. Therefore, the IPG values of the 12 bytes, the 8 bytes, and the 10 bytes may be configurable by a user. Additionally, the three values may be associated with the three packets generated by the transceiver subsystem 28 and encrypted by the MACsec encryption engine 42B.

It should be noted that profiling may enable maintaining and storing of correct MACsec packet sequence numbers during transmission. Each of the PTP packets generated by the transceiver subsystem 28 may include incremental sequence numbers even though they are duplicate packets. Thus, profiling enables the transceiver subsystem 28 to maintain the sequence numbers of each of the PTP packets and/or other data packets being transmitted by the transceiver subsystem 28.

Accordingly, embodiments described herein enable users to implement the single-step PTP with MACsec while accounting for variable latency in the data path of the hardware. Further, embodiments described herein enable an accurate timestamp to be transmitted to the target device to enable proper time synchronization between electronic devices. Thus, hinderances of times synchronization between the electronic device may be reduced, resulting in an improvement in functionality and communication between the electronic devices.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

### EXAMPLE EMBODIMENTS

### Example Embodiment 1.1

An integrated circuit system having transceiver circuitry to carry out operations comprising:
storing a precision time protocol (PTP) packet;
generating a first copy of the PTP packet with a first timestamp, a second copy of the PTP packet with a second timestamp, and a third copy of the PTP packet with a third timestamp;
encrypting each of the first copy of the PTP packet, the second copy of the PTP packet, and the third copy of the PTP packet; and
transmitting either the first copy of the PTP packet, the second copy of the PTP packet, or the third copy of the PTP packet.

### Example Embodiment 2

The integrated circuit system of example embodiment 1, wherein the transceiver circuitry is configurable to enable profiling to predict a first time, a second time, and a third time for the PTP packet to leave a Media Access Control (MAC) pipeline.

### Example Embodiment 3

The integrated circuit system of example embodiment 2, wherein the transceiver circuitry is configurable to generate the first copy of the PTP packet with the first timestamp based on the first predicted time, the second copy of the PTP packet with the second timestamp based on the second predicted time, and the third copy of the PTP packet with the third timestamp based on the third predicted time.

### Example Embodiment 4

The integrated circuit system of example embodiment 1, wherein the transceiver circuitry is configurable to send an indication to disable insertion of a priority flow control frame until a selected packet is transmitted.

### Example Embodiment 5

The integrated circuit system of example embodiment 1, wherein the transceiver circuitry is configurable to compare of each of the first timestamp, the second timestamp, the third timestamp, or any combination thereof, to a time of day (TOD) value to determine which of the first timestamp, the second timestamp, or the third timestamp is closest in value to the TOD value.

### Example Embodiment 6

The integrated circuit system of example embodiment 5, wherein the transceiver circuitry is configurable to select either the first copy of the PTP packet, the second copy of the PTP packet, or the third copy of the PTP packet based on the comparison.

### Example Embodiment 7

The integrated circuit system of example embodiment 6, wherein the transceiver circuitry is configurable to transmit either the first copy of the PTP packet, the second copy of the PTP packet, or the third copy of the PTP packet based on the selection.

### Example Embodiment 8

The integrated circuit system of example embodiment 1, comprising programmable logic circuitry configurable to generate the PTP packet for transmission.

### Example Embodiment 9

The integrated circuit system of example embodiment 1, wherein the transceiver circuitry is configurable to store the PTP packet in a per port buffer.

### Example Embodiment 10

The integrated circuit system of example embodiment 1, wherein the transceiver circuitry is configurable to maintain a history of previously encrypted PTP packets, unencrypted PTP packets, or both, for an associated port for a previous number of clocks.

### Example Embodiment 11

The integrated circuit system of example embodiment 1, wherein the first timestamp, the second timestamp, the third timestamp, or any combination thereof is based on an inter-packet gap (IPG) variance.

### Example Embodiment 12

An electronic device comprising:
Media Access Control security (MACsec) logic configurable to encrypt a first copy of a precision time protocol (PTP) packet associated with a first timestamp, a second copy of the PTP packet associated with a second timestamp, and a third copy of the PTP packet associated with a third timestamp; and
Media Access Control (MAC) logic configurable to compare the first timestamp, the second timestamp, and the third timestamp to a time of day (TOD) value via compare logic to select either the first copy of the PTP packet, the second copy of the PTP packet, or the third copy of the PTP packet for transmission.

### Example Embodiment 13

The electronic device of example embodiment 12, wherein the MACsec logic comprises a MACsec classifier configurable to classify a number of PTP packets and a MACsec encryption engine configurable to encrypt the number of PTP packets.

### Example Embodiment 14

The electronic device of example embodiment 13, wherein the MACsec encryption engine comprises a number of pipeline stages configurable to encrypt the first copy of the PTP packet, the second copy of the PTP packet, the third copy of the PTP packet, or any combination thereof.

### Example Embodiment 15

The electronic device of example embodiment 13, comprising profiling logic configurable to receive information associated with an alignment marker (AM) pulse, a physical coding sublayer (PCS) pulse, an inter-packet gap (IPG) insertion pulse, or any combination thereof.

### Example Embodiment 16

The electronic device of example embodiment 15, comprising a PTP packet generator configurable to receive data from the MACsec classifier, the profiling logic, and timestamp logic to generate the first copy of the PTP packet associated with the first timestamp, the second copy of the PTP packet associated with the second timestamp, and the third copy of the PTP packet associated with the third timestamp.

### Example Embodiment 17

The electronic device of example embodiment 12, comprising a per port PTP buffer configurable to store the first copy of the PTP packet, the second copy of the PTP packet, the third copy of the PTP packet, or any combination thereof until a slot is available at the MAC logic.

### Example Embodiment 18

A tangible, non-transitory, and computer-readable medium having stored thereon instructions, that when executed by a processor, are configurable to cause the processor to:
generate a plurality of packets, wherein each of the plurality of packets is associated with a respective timestamp;
encrypt the plurality of packets;
compare each of the respective timestamp of the plurality of packets to a time of day value; and
select a packet of the plurality of packets that is closest in value to the time of day value.

### Example Embodiment 19

The tangible, non-transitory, and computer-readable medium of example embodiment 18, wherein the instructions, when executed by the processor, are configurable to cause the processor to transmit the selected packet of the plurality of packets.

### Example Embodiment 20

The tangible, non-transitory, and computer-readable medium of example embodiment 18, wherein the instructions, when executed by the processor, are configurable to generate the plurality of packets based on a number of predicted times and the time of day value.

What is claimed is:

1. An integrated circuit system having transceiver circuitry to carry out operations comprising:
storing a precision time protocol (PTP) packet;
generating a first copy of the PTP packet with a first timestamp, a second copy of the PTP packet with a second timestamp, and a third copy of the PTP packet with a third timestamp;
encrypting each of the first copy of the PTP packet, the second copy of the PTP packet, and the third copy of the PTP packet; and
transmitting either the first copy of the PTP packet, the second copy of the PTP packet, or the third copy of the PTP packet.

2. The integrated circuit system of claim 1, wherein the transceiver circuitry is configurable to enable profiling to predict a first time, a second time, and a third time for the PTP packet to leave a Media Access Control (MAC) pipeline.

3. The integrated circuit system of claim 2, wherein the transceiver circuitry is configurable to generate the first copy of the PTP packet with the first timestamp based on the first predicted time, the second copy of the PTP packet with the second timestamp based on the second predicted time, and the third copy of the PTP packet with the third timestamp based on the third predicted time.

4. The integrated circuit system of claim 1, wherein the transceiver circuitry is configurable to send an indication to disable insertion of a priority flow control frame until a selected packet is transmitted.

5. The integrated circuit system of claim 1, wherein the transceiver circuitry is configurable to compare of each of the first timestamp, the second timestamp, the third timestamp, or any combination thereof, to a time of day (TOD) value to determine which of the first timestamp, the second timestamp, or the third timestamp is closest in value to the TOD value.

6. The integrated circuit system of claim 5, wherein the transceiver circuitry is configurable to select either the first copy of the PTP packet, the second copy of the PTP packet, or the third copy of the PTP packet based on the comparison.

7. The integrated circuit system of claim 6, wherein the transceiver circuitry is configurable to transmit either the first copy of the PTP packet, the second copy of the PTP packet, or the third copy of the PTP packet based on the selection.

8. The integrated circuit system of claim 1, comprising programmable logic circuitry configurable to generate the PTP packet for transmission.

9. The integrated circuit system of claim 1, wherein the transceiver circuitry is configurable to store the PTP packet in a per port buffer.

10. The integrated circuit system of claim 1, wherein the transceiver circuitry is configurable to maintain a history of previously encrypted PTP packets, unencrypted PTP packets, or both, for an associated port for a previous number of clocks.

11. The integrated circuit system of claim 1, wherein the first timestamp, the second timestamp, the third timestamp, or any combination thereof is based on an inter-packet gap (IPG) variance.

12. An electronic device comprising:
Media Access Control security (MACsec) logic configurable to encrypt a first copy of a precision time protocol (PTP) packet associated with a first timestamp, a second copy of the PTP packet associated with a second timestamp, and a third copy of the PTP packet associated with a third timestamp; and
Media Access Control (MAC) logic configurable to compare the first timestamp, the second timestamp, and the third timestamp to a time of day (TOD) value via compare logic to select either the first copy of the PTP packet, the second copy of the PTP packet, or the third copy of the PTP packet for transmission.

13. The electronic device of claim 12, wherein the MACsec logic comprises a MACsec classifier configurable to classify a number of PTP packets and a MACsec encryption engine configurable to encrypt the number of PTP packets.

14. The electronic device of claim 13, wherein the MACsec encryption engine comprises a number of pipeline stages configurable to encrypt the first copy of the PTP packet, the second copy of the PTP packet, the third copy of the PTP packet, or any combination thereof.

15. The electronic device of claim 13, comprising profiling logic configurable to receive information associated with an alignment marker (AM) pulse, a physical coding sublayer (PCS) pulse, an inter-packet gap (IPG) insertion pulse, or any combination thereof.

16. The electronic device of claim 15, comprising a PTP packet generator configurable to receive data from the MACsec classifier, the profiling logic, and timestamp logic to generate the first copy of the PTP packet associated with the first timestamp, the second copy of the PTP packet associated with the second timestamp, and the third copy of the PTP packet associated with the third timestamp.

17. The electronic device of claim 12, comprising a per port PTP buffer configurable to store the first copy of the PTP packet, the second copy of the PTP packet, the third copy of the PTP packet, or any combination thereof until a slot is available at the MAC logic.

18. A tangible, non-transitory, and computer-readable medium having stored thereon instructions, that when executed by a processor, are configurable to cause the processor to:
generate a plurality of packets, wherein each of the plurality of packets is associated with a respective timestamp;
encrypt the plurality of packets;
compare each of the respective timestamp of the plurality of packets to a time of day value; and
select a packet of the plurality of packets that is closest in value to the time of day value.

19. The tangible, non-transitory, and computer-readable medium of claim 18, wherein the instructions, when executed by the processor, are configurable to cause the processor to transmit the selected packet of the plurality of packets.

20. The tangible, non-transitory, and computer-readable medium of claim 18, wherein the instructions, when executed by the processor, are configurable to generate the plurality of packets based on a number of predicted times and the time of day value.
